(19) United States
(12) Patent Application Publication
(10) Pub. No.: US 2014/0048467 A1
(43) Pub. Date: Feb. 20, 2014

(54) SEAWATER DESALINATION APPARATUS

(71) Applicant: Kazuo Matsuura, Naruto-shi (JP)

(72) Inventor: Kazuo Matsuura, Naruto-shi (JP)

(21) Appl. No.: 13/983,194

(22) PCT Filed: Feb. 2, 2012
(86) PCT No.: PCT/JP2012/052410

§ 371 Date: Nov. 4, 2013

(30) Foreign Application Priority Data
Feb. 3, 2011 (JP) 2011-022151

(51) Int. Cl. C02F 1/48

(52) U.S. Cl. CPC C02F 1/48
USPC 210/175; 210/243

(57) ABSTRACT

A seawater desalination apparatus includes a spray (1), a gas supplier (9), an atomizing electrode (2), a high voltage power supply (3), a mist classifier (4), and a mist collector (5). The spray includes apertures for producing a seawater mist. The supplier supplies gas for carrying the mist from the spray. The electrode electrostatically produces fine droplets from the mist from the spray. The power supply is connected to the electrode and the spray, and applies high voltage between the electrode and the spray for the production of fine droplets from the mist from the atomizer. The classifier separates the fine droplets in the mist from the electrode. The collector collects the mist discharged from the classifier thereby producing fresh water.

### TECHNICAL FIELD

The present invention relates to an apparatus which produces fresh water from seawater with very high energy efficiency.

### BACKGROUND ART

Fresh water can be produced by distillation of seawater. However, this method requires very large heat energy. The reason is that water with large heat of vaporization is vaporized into water vapor so that the water vapor is cooled and condensed into water liquid. Various desalination apparatuses have been developed which reduce energy in desalination. (See Patent Literatures 1 to 4).

Patent Literature 1 discloses a desalination apparatus for obtaining fresh water by spraying seawater to evaporate the same and liquefying steam after a solidified salt component is separated on a dust state. In this apparatus, seawater is sprayed and evaporated using a Venturi pipe or an injector and the salt component solidified in the dust state is separated by a cyclone and a filter before steam is liquefied. The compressor is compressed to raise a gas temperature in order to improve evaporation efficiency and makes steam pass through the Venturi pipe in order to enhance liquefying efficiency, and atmospheric pressure is lowered to lower the gas temperature.

In a desalination apparatus disclosed in Patent Literature 2, raw water, such as seawater, is desirably introduced into a nozzle capable of spraying it at a size of not more than 10 μm to be sprayed into an atomizing chamber. The atomized raw water is sucked by a fan installed downstream of an adsorbent so as to be adsorbed by the adsorbent. A filtration filter with a pore size of about 1 μm is installed between the atomizing chamber and the adsorbent to remove impurities and raw water particles. Moisture passing through the filtration filter is adsorbed by the adsorbent, and the adsorbent is regenerated by a regenerating apparatus to obtain high-humidity moisture, which is condensed to obtain freshwater.

Also, in a desalination apparatus disclosed in Patent Literature 3, seawater is introduced into a nozzle capable of spraying the water of a size of not more than 10 μm, and then sprayed into an atomizing chamber. The atomized raw water is adsorbed by an adsorbent, and the adsorbent is regenerated by a regeneration means to obtain high-humidity moisture, and the moisture is condensed to obtain fresh water with low energy and energy saving. In this desalination apparatus, a carburetor is used to atomize the seawater, or the seawater is subjected to supersonic vibration so that water droplets and water vapor are diffused from the interface of the seawater and air into the air by the vibration.

In a desalination apparatus disclosed in Patent Literature 4, the evaporation area can be enlarged, and the energy of desalination can be reduced using solar power with low vaporization cost. The desalination apparatus includes an evaporator-desalter which has a heat absorbing roof and atomizers. Water containing salt such as seawater is supplied to this apparatus from a water pool through intake an intake means. This apparatus further includes a vapor and condensate discharge means. This vapor and condensate discharge means is at least a portion of the water pool. The density of the water in the water pool is higher than that of the water being desalinated. The atomizers, the roof, and the vapor and condensate discharge means are arranged above the surface of the water pool.

### CITATION LIST

### Patent Literature

[Patent Literature 1] Japanese Patent Laid-Open Publication No. JP 2008-43933 A

[Patent Literature 2] Japanese Patent Laid-Open Publication No. JP 2007-245014 A

[Patent Literature 3] Japanese Patent Laid-Open Publication No. JP 2007-237140 A

[Patent Literature 3] Japanese Patent Laid-Open Publication No. H06-226247 A

### Technical Problem

In the aforementioned desalination apparatuses, seawater is atomized to enhance vaporization, and the vaporized water vapor is cooled and condensed or is absorbed by adsorbent whereby collecting the water. These apparatuses consume less energy as compared with the desalination method which distills water from seawater. However, in these apparatuses, since the vaporized water vapor is cooled and condensed or is absorbed by adsorbent whereby collecting the water, there is a disadvantage that the reduction of desalination energy is not enough.

The present invention has been developed to further reduce energy in use. It is an important object of the present invention to provide a seawater desalination apparatus which can efficiently desalinate a large amount of seawater with very low energy consumption.

### Solution to Problem and Advantageous Effects of Invention

A seawater desalination apparatus according to the present invention includes a spray 1, a gas supply device 9, an atomizing electrode 2, a high voltage power supply 3, a mist classifier 4, and a mist collector 5. The spray 1 includes a plurality of spraying apertures that spray seawater and produce a mist of the seawater. The gas supply device 9 supplies carrying gas for carrying the spray mist, which is produced by the spray 1. The atomizing electrode 2 electrostatically produces fine droplets as an atomization mist from the spray mist, which is produced by the spray 1. The high voltage power supply 3 is connected to the atomizing electrode 2 and the spray 1, and applies a high voltage between the atomizing electrode 2 and the spray 1 for the production of fine droplets from the spray mist, which is produced by the atomizer 1. The mist classifier 4 classifies the fine droplets as an atomization mist, which are produced by the atomizing electrode 2, according to the particle sizes of the fine droplets. The mist collector 5 collects the fine droplets as an atomization mist, which are classified by the mist classifier 4, whereby producing fresh water.

The thus-constructed seawater desalination can efficiently desalinate a large amount of seawater with very low energy consumption. The reason is that, according to the thus-constructed desalination apparatus, after seawater is electrostatically atomized whereby providing an atomized mist of the seawater to the carrying gas, the atomized mist is classified by the mist classifier according to the particle sizes of droplets of the atomized mist, and then the mist collector collects very fine droplets of the atomized mist which does not contain salt whereby producing fresh water. The thus-constructed seawater desalination apparatus produces fresh water not only by collecting water vapor which is vaporized and provided to carrying gas. When water vapor is collected which is contained in the carrying gas, a large amount of heat of vaporization is absorbed, that is, a large amount of energy is required to cool the water vapor. When the water vapor liquefies, a large amount of heat of condensation is generated. For this reason, it is required to cool the heat energy corresponding to this heat of condensation. On the other hand, when not water vapor but fine droplets of a mist are collected, it is not required to absorb the heat energy corresponding to the heat of condensation of water. Accordingly, it is possible to extremely reduce the heat energy required for collecting fine droplets of the mist when fresh water is produced. Electrostatic atomization can atomize seawater into very fine droplets of a mist. When seawater is atomized into fine droplets of a mist, the salt concentration gets lower as the particle size of the droplet of the mist decreases. A droplet of the mist of nano order size will contain almost no salt and will be a fresh water droplet. The molecular bond strength between water and NaCl is low, while the molecular bond strength between water molecules is high. For this reason, a very fine droplet of the mist contains almost no salt. Consequently, since fine droplets of a mist are collected almost without vaporization into water vapor, the heat energy can be reduced when fine droplets of mist are cooled and collected whereby producing fresh water. The electrostatic atomization produces, from a mist sprayed from nozzle, finer droplets of a mist by using an electrostatic effect. After electrostatic atomization, the mist will contain a large amount of fine droplets with very low salt concentration of ppm order substantially corresponding to fresh water. The mist classifier classifies droplets of a mist according to the particle size of the droplets, and discharges fine droplets of the mist corresponding to fresh water together with the carrying gas. According to the present invention, since the fine droplets of the mist, which is not in the water vapor state, are collected from the carrying gas discharged from the mist classifier, it is possible to efficiently collect the fine droplets of the mist whereby producing fresh water with reduced heat energy when cooling the fine droplets of the mist. This seawater desalination apparatus of the present invention can reduce energy consumed for collecting the fine droplets of the mist (i.e., energy required for cooling the fine droplets of the mist) to an integral submultiple of energy consumed for liquefying and collecting water vapor. Thus, the energy consumed for the collection in the present invention can be extremely reduced.

Since fresh water can be produced by the thus-constructed desalination apparatus with cooling energy which is an integral submultiple of heat of condensation for collecting water vapor, it is clearly conceived that the thus-constructed desalination apparatus collects not only vaporized water vapor but also a mist of fresh water.

In order to atomize seawater into fine droplets of a mist, seawater may be subjected to supersonic vibration. This supersonic vibration also can atomize seawater into fine droplets of a mist substantially corresponding to fresh water. The desalination apparatus according to the present invention atomizes seawater into fine droplets of a mist by using electrostatic atomization instead of supersonic vibration. The electrostatic atomization does not require short-life ultrasonic vibrators which are used in the supersonic vibration, and does not necessarily apply high-frequency power which is used for ultrasonic vibrators. Therefore, it is possible to atomize a large amount of seawater into fine droplets of a mist with lower power consumption by using very simple construction. According to this inventors' experiment, the power consumption of electrostatic atomization, which can be used in the desalination apparatus of the present invention, is reduced to about one-third of the supersonic vibration when the same amount of seawater is atomized into a mist. This means that the electrostatic atomization can extremely save energy. Consequently, the electrostatic atomization can efficiently atomize seawater into a mist. As discussed above, the desalination apparatus of the present invention extremely improves both the atomization efficiency for atomizing seawater into a mist, and the collection efficiency for collecting the atomized mist and producing fresh water. As a result, the desalination apparatus of the present invention can extremely efficiently produce fresh water from a large amount of seawater. This is very important feature for this type of apparatus.

In addition, according to the seawater desalination apparatus of the present invention has a sterilization effect through the action of static electricity in electrostatic atomization for production of fresh water. Ozone is produced by high voltage when seawater is atomized into a fine mist. This ozone has a sterilization effect on the atomized mist. Therefore, according to the thus-constructed seawater desalination apparatus can simplify pretreatment of seawater and additionally can efficiently produce the sterilized fresh water.

In a seawater desalination apparatus according to the present invention, the mist classifier 4 can be a cyclone classifier 70. According to this seawater desalination apparatus, when the mist of the carrying gas discharged from the cyclone 70 is collected, the salt concentration of the produced fresh water can be about 50 ppm, which corresponds to fresh water substantially close to pure water.

In a seawater desalination apparatus according to the present invention, the mist collector 5 can be a cooling collector 50 which cools the carrying gas containing the mist whereby producing fresh water. Since the cooling collector 50 cools the carrying gas containing fine droplets of the mist whereby producing fresh water, water vapor of fresh water can be collected together with the mist.

In a seawater desalination apparatus according to the present invention, the atomizer 1 can include a plurality of atomizing units 10. Each of the spraying units 10 can include a number of fine spraying apertures 12 as the plurality of spraying apertures for electrical discharge in cooperation with the atomizing electrode 2 whereby producing the fine droplets as the atomization mist. The atomizing electrode 2 produces the fine droplets as the atomization mist from the spray mist produced from each of the fine atomizing apertures 12.

According to the thus-constructed seawater desalination apparatus, in addition to the feature that a large amount of seawater can be atomized into a mist, almost all the mist can be atomized into fine droplets. The reason is that, according to the thus-constructed seawater desalination apparatus, the spray for producing a mist is composed of a plurality of spray units, each of the spraying units including a number of fine spraying apertures for electrical discharge in cooperation with the atomizing electrode whereby producing the fine droplets as the atomization mist. The atomizing electrode produces the fine droplets as an atomization mist from the spray mist produced from each of the fine atomizing apertures.

In a seawater desalination apparatus according to the present invention, a spray case 7 can be further included which has a spray chamber 21. The spray unit 10 sprays the seawater into the spray chamber and producing the mist of the seawater. The spray case 7 can have a blowing aperture 24 through which the carrying gas is blown into the space between the spray units 10 adjacent to each other. The blowing aperture 24 can be communicated with the gas supply device 9.

According to the thus-constructed seawater desalination apparatus, since the atomization mist is dispersed by the carrying gas supplied from the blowing aperture, it is possible to prevent that the droplets of the mist aggregate and that the size of the droplets increases. Therefore, it is possible to efficiently produce fine droplets of a mist.

In a seawater desalination apparatus according to the present invention, the spray case 7 can be connected to the mist classifier 4 such as a cyclone classifier.

According to the thus-constructed seawater desalination apparatus, after fine droplets of atomization mist produced in the spray case is supplied together with the carrying gas to the mist classifiers such as a cyclone classifier, fine droplets of an atomization mist can be classified according to the particle sizes of the droplets through the action of centrifugal force in the cyclone classifier.

In a seawater desalination apparatus according to the present invention, the atomizing electrode 2 can be arranged on the path of the carrying gas, which is blown through the blowing aperture 24, in the spray chamber 21.

According to the thus-constructed seawater desalination apparatus, it is possible to provide efficient electrical discharge by means of the atomization electrode whereby producing fine droplets of an atomization mist from the spray mist. The reason is that the atomization electrode can be held in a preferred insulating state by the carrying gas blown toward the atomization electrode. The atomization electrode in the insulating state is held in a preferred electrically-dischargeable state, and can efficiently atomize the spray mist into fine droplets.

In a seawater desalination apparatus according to the present invention, a spray case 67 can be further included which has a spray chamber 61. The spray unit 10 sprays the seawater into the spray chamber and produces the mist of the seawater. The spray case 67 can be a cyclone classifier 70 as the mist classifier 4. The cyclone classifier 70 can include a drain outlet 32 and an air outlet 33. The drain outlet 32 limits the discharge of the carrying gas, and drains the mist which drops in the spray chamber 61. The air outlet 33 is opened in the central part of the cyclone classifier, and discharges the mist carried together with the carrying gas. The carrying gas containing the mist can be carried into the mist collector 5 after discharged through the air outlet 33.

According to the thus-constructed seawater desalination apparatus, it is possible to remove larger droplets in the mist, which have not been atomized into fine droplets by the atomization electrode. Therefore, it is possible to extremely reduce the mean particle size of the mist discharged from the cyclone classifier. In addition, according to this desalination apparatus, since the spray case 67 also serves as the mist classifier 4, the construction of the desalination apparatus can be simplified.

In a seawater desalination apparatus according to the present invention, the spray case 7 or 67 can include an attachment portion 20 or 40 that detachably holds a plurality of spray units 10 so that the detachably-held spray units 10 can be replaced.

According to the thus-constructed seawater desalination apparatus, since the spray unit 10 can be easily replaced, the maintenance can be easy, for example, when a nozzle becomes clogged, which in turn can constantly produce fine droplets of a mist.

In a seawater desalination apparatus according to the present invention, the inside diameter of the fine spray aperture 12 can be not more than 0.5 mm.

According to the thus-constructed seawater desalination apparatus, such a fine spray aperture can reduce the particle sizes of droplets of a mist sprayed from the aperture, and in addition the mist is atomized into fine droplets by electrical discharge of the atomization electrode. Therefore, it is possible to reduce the mean particle size of the mist sprayed from the spray unit.

In a seawater desalination apparatus according to the present invention, the number of fine spraying apertures 12 of the spray unit 10 can be not less than ten.

According to the thus-constructed seawater desalination apparatus, since a mist is sprayed from the spray unit which has a number of fine spray apertures, a large amount of fine mist can be produced per unit time.

### BRIEF DESCRIPTION OF DRAWINGS

FIG. 1 is a schematic view showing a seawater desalination apparatus according to an embodiment of the present invention.

FIG. 2 is a schematic view showing a seawater desalination apparatus according to another embodiment of the present invention.

FIG. 3 is a schematic view showing a seawater desalination apparatus according to another embodiment of the present invention.

FIG. 4 is an enlarged cross-sectional view of the seawater desalination apparatus shown in FIG. 1 corresponding to the cross-sectional view taken along the line IV-IV shown in FIG. 6.

FIG. 5 is a bottom perspective view of a spray unit shown in FIG. 4.

FIG. 6 is a bottom view of the spray unit shown in FIG. 5.

### DESCRIPTION OF EMBODIMENTS

The following description will describe embodiments according to the present invention with reference to the drawings. It should be appreciated, however, that the embodiments described below are illustrations of a seawater desalination apparatus used therein to give a concrete form to technical ideas of the invention, and a seawater desalination apparatus of the invention is not specifically limited to description below. In this specification, reference numerals corresponding to components illustrated in the embodiments are added in “Claims” and “Solution to Problem” to aid understanding of claims. However, it should be appreciated that the members shown in claims attached hereto are not specifically limited to members in the embodiments.

The seawater desalination apparatus of the present invention electrostatically atomizes seawater whereby producing fine droplets of a mist from the seawater. Subsequently, a mist classifier separates a mist of fresh water (i.e., fine droplets of a mist and water vapor) from a mist of the seawater. After that, a mist collector collects the mist of fresh water. A seawater desalination apparatus according to the present invention includes a spray 1, a gas supply device 9, an atomizing electrode 2, a high voltage power supply 3, a mist classifier 4, and a mist collector 5. The spray 1 sprays seawater. The gas supply device 9 supplies carrying gas to the spray 1. The atomizing electrode 2 electrostatically produces fine droplets as an atomization mist from the spray mist, which is produced by the spray 1. The high voltage power supply 3 is connected to the atomizing electrode 2 and the spray 1, and applies a high voltage between the atomizing electrode 2 and the spray 1 for the production of fine droplets from the spray mist, which is produced by the atomizer 1. The mist classifier 4 removes larger droplets of a mist from the atomization mist atomized with the atomization electrode 2, and discharges fine droplets of the atomization mist of fresh water and water vapor together with the carrying gas. The mist collector 5 collects the fine droplets of fresh water as an atomization mist, which are discharged from the mist classifier 4, whereby producing fresh water.

In the illustrated desalination apparatus, the mist classifier 4 is a cyclone classifier 70, while the mist collector 5 is a cooling collector 50 which cools the carrying gas. The cyclone classifier 70 has very simple construction but can remove larger droplets of a mist of seawater from the carrying gas and transfers fine droplets of the atomization mist of fresh water and water vapor by using the carrying gas. However, in the seawater desalination apparatus of the present invention, the mist classifier is not limited to cyclone classifiers. Any devices can be used which can classify larger droplets of a mist from a mist contained in carrying gas, such as demister, punching metal, filter, and chevron plate. These types of mist classifiers pass fine droplets of a mist, which are the fresh water, together with the carrying gas, and collect larger droplets, which are seawater, after the larger droplets collide with each other.

The cooling collector 50 collects fine droplets of a mist of fresh water, and additionally collects water vapor as fresh water by cooling and liquefying the water vapor. Thus, the mist and water vapor as fresh water can be more efficiently collected from the carrying gas. Although the carrying gas contains vapored water vapor as fresh water and fine droplets of a mist of fresh water, a device may be used which collects only fine droplets of a mist of fresh water. Accordingly, the mist collector is not limited to a cooling collector which cools the carrying gas. Any devices may be used which can collect fine droplets of a mist included in carrying gas. For example, an electrostatic dust collector or the like may be used which absorbs fine droplets of a mist through electrostatic action.

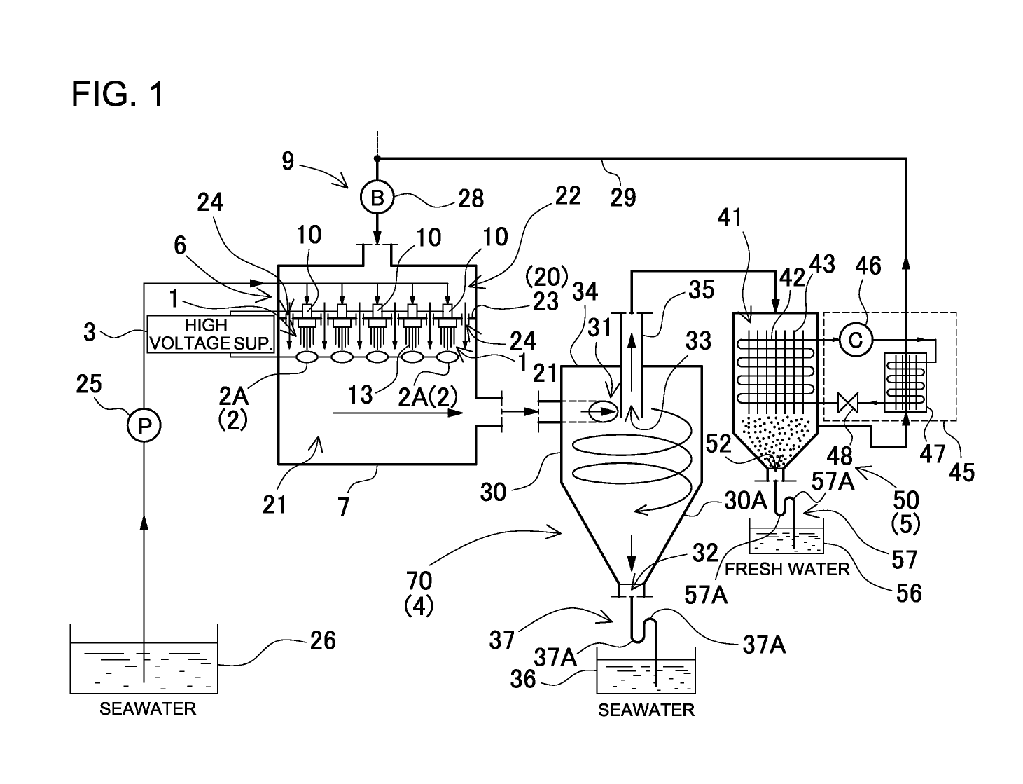

Each of desalination apparatuses shown in FIGS. 1 to 3 includes the electrostatic atomizer 6 or 66 which sprays seawater from spray 1 and produces fine droplets of a mist from the seawater. The electrostatic atomizer 6 or 66 includes a closed spray case 7 or 67 which accommodates the spray 1 in the upper part of the spray case. Seawater is sprayed from the upper side toward the lower side. The electrostatic atomizer 6 or 66 includes atomization electrodes 2 which are arranged in the spray case 7 or 67 and produce fine droplets from the mist sprayed from the spray 1 through electrostatic action.

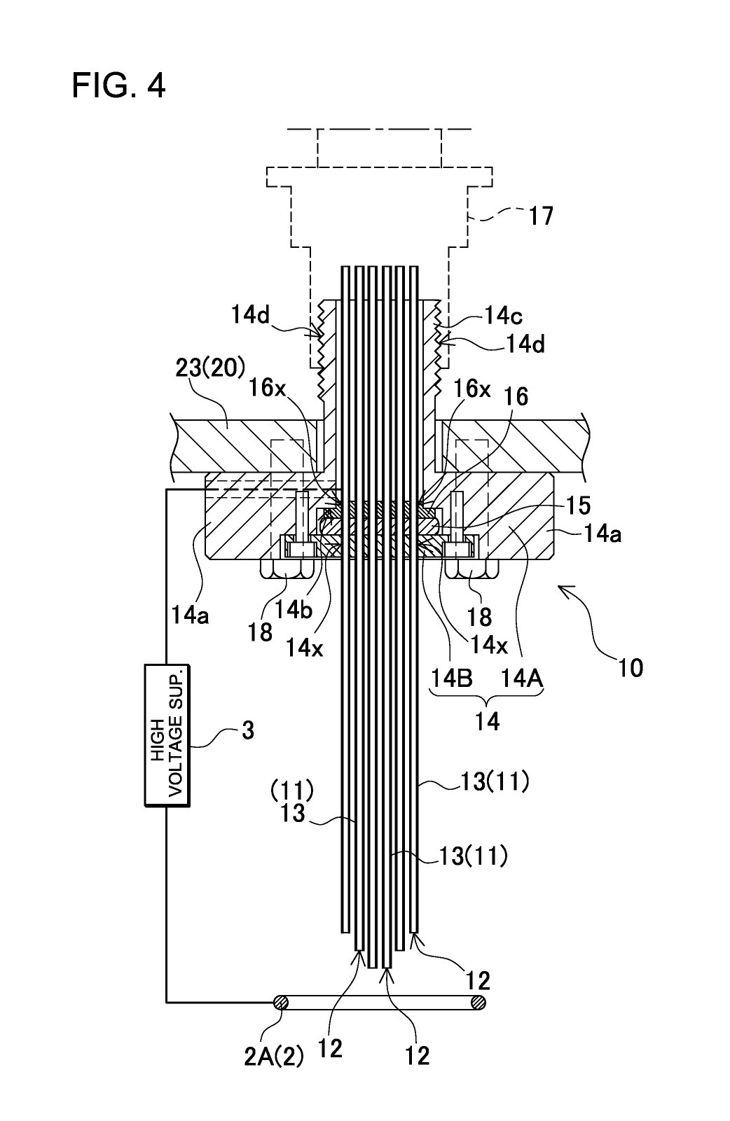

In the illustrated electrostatic atomizer 6 or 66, the spray 1 is composed of a plurality of spray units 10 which are arranged in the spray case 7 or 67. FIGS. 4 to 6 show the spray unit 10. The spray unit 10 shown in these Figures includes a plurality of capillary tubes 13 which are attached in parallel to each other to a nozzle block 14. The capillary tube 13 is a small metal tube with inside diameter of 0.1 to 0.2 mmφ. Pressurized seawater is sprayed from the end of the capillary tube whereby producing a mist.

A disk-shaped flange 14a is arranged on the outer peripheral part of the nozzle block 14. The capillary tubes 13 in the central part of the flange. The nozzle block 14 shown in FIGS. 4 to 6 has a main portion 14A and a plate-shaped portion 14B. The main portion 14A has the flange 14a. The capillary tubes 13 are secured to the plate-shaped portion 14B. The plate-shaped portion 14B is attached to the main portion 14A by screws. The plate-shaped portion 14B has through holes 14x into which the capillary tubes 13 are inserted. The inner shape of the through hole 14x is substantially equal to the outer shape of the capillary tube 13. The capillary tube 13 is inserted substantially without gap into the through hole 14x. In order to prevent liquid leakage between the capillary tube 13 and the through hole 14x, a packing member 15 is arranged on the inner surface of the plate portion 14B. The packing member 15 is a rubber-like elastic member, and airtightly seals the gap between the capillary tube 13 and the plate portion 14B. In order to that the packing member 15 can be compressively attached, a sandwiching plate 16 is provided. The packing member 15 is attached to the main portion 14A with being compressed between the plate portion 14B and the sandwiching plate 16. The sandwiching plate 16 also has through holes 16x. The sandwiching plate 16 is arranged on a stepped portion 14b of the main portion 14A. The packing member 15 is elastically compressed by the plate-shaped portion 14B, which is attached to the main unit portion 14A. Thus, the packing member 15 is attached to the main portion 14A. Also, the main portion 14A has a cylindrical portion 14c which protrudes from the back surface. The cylindrical portion 14c has an inner shape which can accommodate the capillary tubes 13, and an outer shape the surface of which external threads 14d are formed. The capillary tubes 13 are arranged inside the cylindrical portion 14c of the main portion 14A. The end part of the cylindrical portion 14c is screwed into a supply socket 17 for supplying seawater.

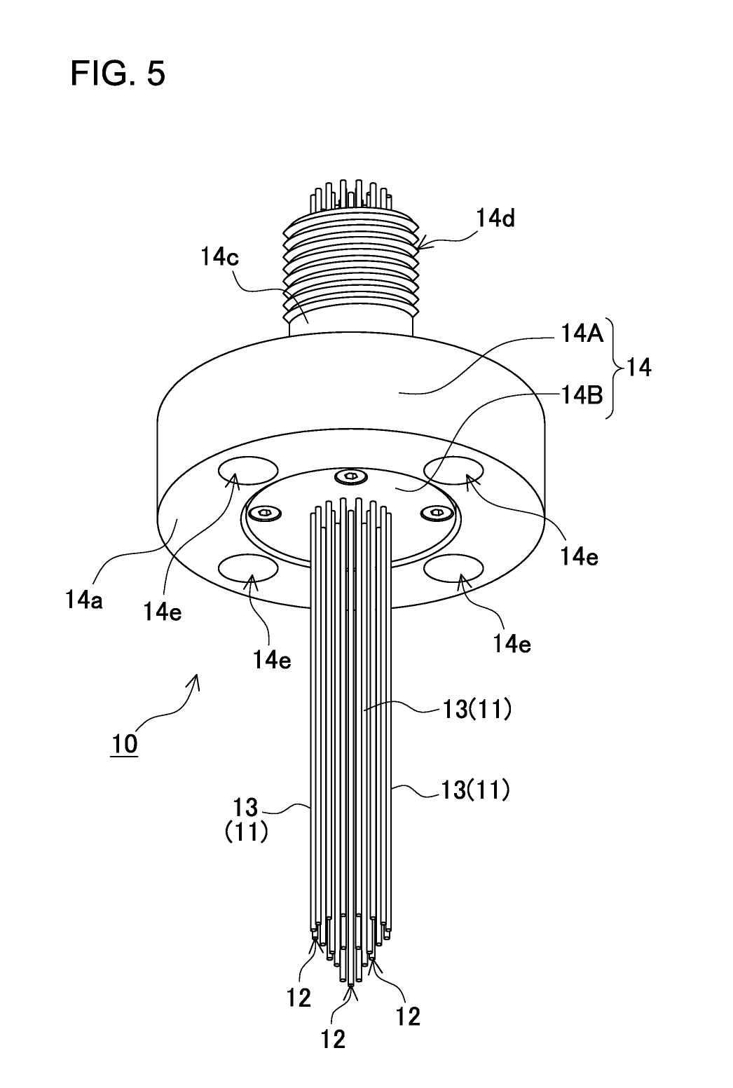

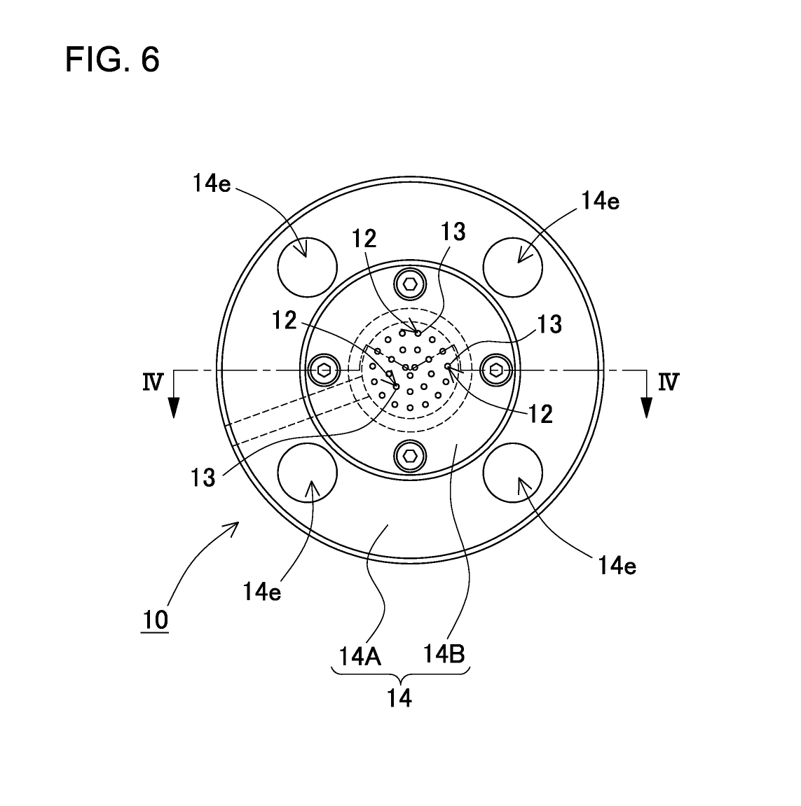

The through holes 14x are arranged on a plurality of ring-shaped lines on the plate-shaped portion 14B of the nozzle block 14 shown in FIG. 6. The capillary tubes 13 protrude from the nozzle block 14. The ends of the capillary tubes 13 serve as electrical discharge protruding portions 11. The inner center apertures of the capillary tubes 13 serve as fine spray apertures 12. The number of the capillary tubes 13 attached to the nozzle block 14 determines the number of the fine spray apertures 12 of the spray unit 10. The spray unit 10 preferably has ten or more, more preferably twenty or more, and still more preferably thirty or more fine spray apertures 12. Thus, the amount of mist sprayed by one spray unit 10 can be increased. If the number of the fine spray apertures 12 is too much, the entire size of the spray unit 10 will be large. For this reason, the spray unit 10 includes not more than one hundred fine spray apertures 12. In the spray unit 10 shown in FIGS. 4 and 5, the protruding amount of the capillary tube 13 arranged in the center part of the nozzle block 14 is higher than the capillary tubes 13 on the outer peripheral part so that the imaginary surface defined by the ends of many capillary tubes 13 has a convex shape the highest point is located at the center of the nozzle block. However, the protruding amounts of the capillary tubes in the spray unit may be equal to each other so that the imaginary surface defined by the ends of many capillary tubes may be flat.

The aforementioned spray unit 10 includes a number of small tubes as capillary tubes 13, and sprays seawater through the capillary tubes 13 whereby producing a mist. The spray unit may include a perforated plate which has a number of fine spray apertures instead of the capillary tubes. The perforated plate can be formed of an electrically-conductive material such as metal. The perforated plate can be manufactured by forming fine spray apertures on the metal plate by using laser. Also, the perforated plate may be formed of a sintered metal with fine spray apertures. The electrically-conductive perforated plate is connected to the high voltage power supply so that high voltage can be applied between the perforated plate and the atomization electrode. However, the perforated plate is not necessarily formed of an electrically-conductive material. Seawater has conductivity. For this reason, when high voltage is applied between the atomization electrode and seawater which is sprayed through the spray apertures, the sprayed mist can be atomized through the electrostatic action. From this viewpoint, the perforated plate can be an open-cell plastic foam material in which there is interconnection between the cells.

In the spray case 7 or 67, the atomization electrodes 2 are electrically insulated from the spray 1. A high voltage is applied the atomization electrode 2 relative to the spray 1. For this reason, the atomization electrode 2 and the spray 1 are attached to the spray case 7 or 67 with being electrically insulated from each other. In the case where the electrostatic atomizer is attached to a metal spray case without being electrically insulated from metal spray case, the atomization electrode is electrically insulated from the spray case. On the other hand, in the case where the electrostatic atomizer is electrically insulated from the spray case, the atomization electrode can be directly attached to the spray case. It should be noted that both the spray and the atomization electrode can be attached to the spray case with being electrically insulated from the spray case.

A mist sprayed from the spray 1 is atomized into fine droplets by electrical discharge between the atomization electrode 2 and the discharge protruding portion 11 of the spray 1. The atomization electrode 2 is spaced away from the fine spray apertures 12 and is arranged forward of the fine spray apertures 12 in the spraying direction. The atomization electrodes 2 shown in FIGS. 1, 3 and 4 are an annular metal ring 2A which is arranged at a position corresponding to the periphery of the nozzle block 14, and are arranged at a position corresponding to the peripheries of the capillary tubes 13, which is attached to the nozzle block 14. The atomization electrode 2 which is the metal ring 2A shown in FIG. 1 is located on the path of the carrying gas which is blown through the blowing aperture 24. Accordingly, it can be suppressed that the blown carrying gas causes the mist to adhere to the atomization electrode 2.

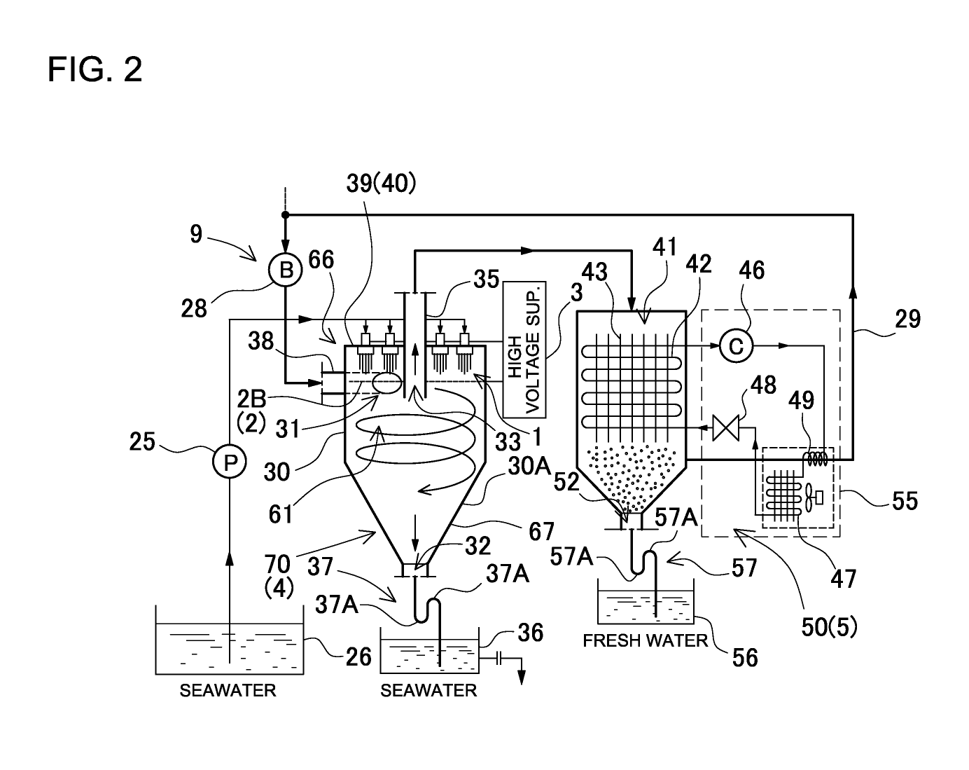

The atomization electrode 2 shown in FIG. 2 is a metal net 2B, and is spaced away from the discharge protruding portions 11 in the mist spraying direction. A mist sprayed through the fine spray aperture 12 is atomized into fine droplets by uniform electrical discharge between the atomization electrode 2 of metal net 2B and each of the discharge protruding portion 11.

The atomization electrode 2 is arranged forward of the spray unit 10. In the case of the electrostatic atomizers 6 and 66 of FIGS. 1 to 3, the spray 1 sprays seawater downward whereby producing a mist. Correspondingly, the atomization electrode 2 is arranged under of the spray unit 10.

The high voltage power supply 3 applies high voltage between the spray unit 10 and the atomization electrode 2. The high voltage power supply 3 is a DC power supply. The positive side is connected to the atomization electrode 2, while the negative side is connected to the spray unit 10. It should be noted that the positive side can be connected to the spray unit, while the negative side can be connected to the atomization electrode.

In the electrostatic atomizer 6 shown in FIG. 1, a closed chamber is formed in the upper part of the spray case 7, and serves as an air chamber 22. In order to form the air chamber 22, a partitioning wall 23 is airtightly secured to the upper part of the spray case 7. The partitioning wall 23 partitions the interior space of the spray case 7 into the air chamber 22 and a spray chamber 21, and serves as an attachment portion 20 to which the spray 1 is attached. Thus, the spray units 10 are attached at predetermined positions. The spray units 10 of the spray 1 are attached to the partitioning wall 23 as the attachment portion 20 for spraying seawater whereby producing a mist in the spray chamber 21. As shown in FIGS. 4 and 5, the spray unit 10 is detachably attached to the partitioning wall 23 as the attachment portion 20 by coupling bolts 18 which penetrate the coupling holes 14e which open in the flange 14a of the nozzle block 14.

The air chamber 22 has a closing structure, and is connected to a blower 28 of a gas supply device 9. Thus, the carrying gas, which is forcedly blown by the blower 28, can be discharged from the air chamber 22 into the spray chamber 21 through the blowing apertures 24, which penetrate the partitioning wall 23. The blowing aperture 24 are a slit-shaped through hole, and are arranged between the spray units 10 so that the blown carrying gas is discharged toward parts under the peripheries of the spray units 10. It should be noted that the blowing apertures are not necessarily have a slit shape. A plurality of through holes with round or polygonal shape can be formed as the blowing apertures between spray units so that the carrying gas can be discharged toward parts under the parts between spray units. The atomization mist is carried together with the carrying gas which is discharged thorough the blowing apertures 24 to the spray chamber 21. In the spray case 7 shown in FIG. 1, the blowing apertures 24 are formed between the adjacent spray units 10. After discharged through the blowing apertures 24 into the spray chamber 21, the carrying gas carries a mist, which is produced into fine droplets by the atomization electrode 2 after spraying of the spray unit 10, to the cyclone classifier 70 of the mist classifier 4 for the subsequent process and to the cooling collector 50 of the mist collector 5.

In the spray 1, as shown in FIG. 1, the spray units 10 is attached onto the spray chamber 21 side of the partitioning wall 23 for spraying seawater and producing a mist in the spray chamber 21. The spray 1 is connected to a pump 25 which supplies pressurized seawater. The pump 25 draws seawater stored in the seawater tank 26 or directly draws seawater from the sea. After that, the pump 25 pressurizes the seawater and supplies the seawater to the spray units 10. The pump 25 filters seawater by using a filter, and supplies the filtered seawater to the spray 1. The filter removes foreign matter which may clog the spray 1. When the discharging pressure of the pump 25 is high, the discharging rate of seawater is increased which is sprayed from the spray unit 10, which in turn can make the mean particle size of droplets of mist small. However, the mean particle size of droplets of mist depends not only on the pressure of seawater supplied from the pump 25 but also on the structure of the spray unit 10. From this reason, when the pump 25 pressurizes seawater and supplies the pressurized seawater to the spray units 10, the pressure of the seawater is set to an optimum value in consideration of the structure of the spray unit 10 and the required particle size of droplets of mist. However, the pressure of the seawater is set to preferably not less than 0.1 MPa, more preferably to not less than 0.2 MPa, and still more preferably to not less than 0.3 MPa. If the pressure of the seawater is high which is supplied by the pump 25 to the spray units 10, the pump 25 will be expensive, and the power consumption of a motor will be high which operates the pump 25, which in turn increases running costs. For this reason, when the pump 25 supplies the pressurized seawater to the spray units 10, the pressure of the seawater is set to preferably not less than 1 MPa, more preferably to not less than 0.8 MPa, and still more preferably to not less than 0.7 MPa, for example. When the pump 25 pressurizes seawater and supplies the pressurized seawater to the spray units 10, the pressure of the seawater is preferably set to 0.3 to 0.6 MPa.

The cyclone classifier 70 of the mist classifier 4 separates a mist which is included in the carrying gas supplied from the electrostatic atomizer 6 into fine droplets of a mist of fresh water and larger droplets of a mist of seawater by centrifugal means. That is, the cyclone classifier 70 removes larger droplets of a mist of seawater. After that, the cyclone classifier 70 discharges the fine droplets of a mist of fresh water and vaporized water vapor of fresh water by using the carrying gas to the cooling collector 50 of the mist collector 5 for the subsequent process. In the desalination apparatus shown in FIG. 1, the cyclone classifier 70 of the mist classifier 4 is connected to the discharging side of the electrostatic atomizer 6 so that the fine droplets of atomization mist, which is atomized by the electrostatic atomizer 6 is carried to the cyclone classifier 70 together with the carrying gas. The cyclone classifier 70 has a cylindrical portion 30 and a tapered portion 30A. The cylindrical portion 30 has a cylindrical shape. The top end of the cylindrical portion 30 is closed by a top plate 34. The tapered portion 30A is tapered down downward from the lower end of the cylindrical portion 30. The cyclone classifier 70 has an inlet 31, a drain outlet 32, and an air outlet 33. The carrying gas containing a mist is flown into the cyclone classifier 70 in the tangential direction of the cyclone classifier 70 through the inlet 31. The larger droplets are drained through the drain outlet 32 after the larger droplets are spirally moved downward along the outer peripheral part of the cyclone classifier 70 by centrifugal force and separated from smaller droplets. The fine droplets of a mist of fresh water are discharged upward through the air outlet 33 after gathering in the central part of the cyclone classifier 70.

After being flown into the cyclone classifier 70 of the mist classifier 4 through the inlet 31, a mist rotates together with the carrying gas so that droplets of the mist are separated into larger droplets and smaller droplets according to the particle sizes of the droplets of the mist by centrifugal means. When the droplets of the mist rotates in the cyclone classifier 70, the centrifugal force applied to the droplets varies according to the particle sizes of the droplets. The centrifugal force applied to the droplets of the mist receives is proportional to the mass of the droplets of the mist. For this reason, a larger centrifugal force is applied to droplets of the mist with a larger particle size so that the larger droplets are moved toward the inner surface of the cyclone classifier 70 and then gather and flow downward along the inner surface of the cyclone classifier 70. Thus, liquid produced by the gathering larger droplets is drained through the drain outlet 32. Since the mass is smaller of droplets of a mist with smaller particle size and gas vaporized from a mist, the smaller droplets of a mist and the vaporized gas gather in the central part of the cyclone classifier and are discharged through the air outlet 33.

In the cyclone classifier 70 shown in FIG. 1, the inlet 31 is opened on the inner surface of the upper part of the cylindrical portion 30. The carrying gas supplied from the electrostatic atomizer 6 is flown in the tangential direction of the cylindrical portion 30 through the inlet 31. In the cyclone classifier 70, the drain outlet 32 is formed at the lower end of the tapered portion 30A. Larger droplets of a mist gather and move downward along the inner surface of the cyclone classifier 70. Also, droplets drop from the atomization electrode 2 after adhering onto the atomization electrode 2. The collecting tank 36 collects the gathering larger droplets of a mist and the droplets dropping from the atomization electrode 2 through the drain outlet 32. The drain outlet 32 has a discharge liquor trap 37 which is bent in a U shape and prevents the carrying gas from being discharged. The discharge liquor trap 37 is formed from two U-bent parts 37A, and stores a certain amount of discharge liquor to be discharged whereby preventing the carrying gas from being discharged. According to this construction, the carrying gas can be completely prevented from being discharged, while the dropping liquid can be collected. It should be noted that the drain outlet can use a filter which prevents the carrying gas from passing through the filter but allows the liquid to pass through the filter so that the carrying gas is preventing from being discharged while the liquid can pass through the drain outlet.

The cyclone classifier 70 shown in FIG. 1 has the air outlet 33 which is opened at the center of the top plate 34 for discharging the carrying gas. In the illustrated cyclone classifier 70, a discharge duct 35 is arranged at the center of the top plate 34, and penetrates the top plate 34 so that the air outlet 33 is opened in the interior space of the cyclone classifier 70. Thus, after the cyclone classifier 70 separates the fine droplets from a mist of seawater, carrying gas containing fine droplets of a mist of fresh water is discharged upward from the cyclone classifier 70 and carried for the subsequent process.

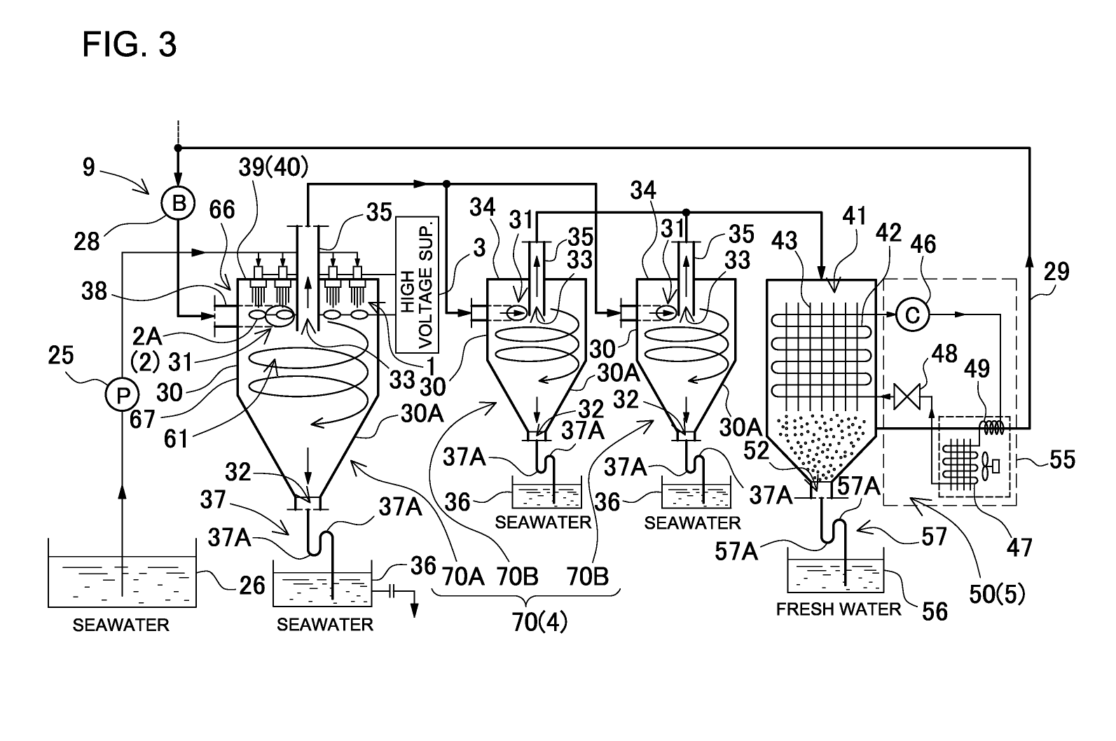

In the desalination apparatuses shown in FIGS. 2 and 3, the spray case 67 of the electrostatic atomizer 66 also serves as the cyclone classifier 70 of the mist classifier 4. In order that the illustrated spray case 67 may also serve as the cyclone classifier 70, the spray case 67 has the cylindrical portion 30. The cylindrical portion 30 has a cylindrical shape as a whole. The top end opening of the cylindrical portion 30 is closed by a top plate 39. The spray 1 and the atomization electrode 2 are arranged in the upper part of the cylindrical portion 30. Thus, the interior of the spray case 67 serves as a spray chamber 61 in which a mist is produced. The tapered portion 30A is tapered down downward from the lower end of the cylindrical portion 30. In the illustrated electrostatic atomizer 66, the top plate 39 of the spray case 67 serves as an attachment portion 40 to which the spray 1 is attached. The spray units 10 are secured at predetermined positions on the attachment portion 40. The spray units 10 of the spray 1 are attached onto the interior surface of the top plate 30 as the attachment portion 40, and faces downward. Thus, the spray units 10 spray seawater from the top toward the bottom in the spray chamber 61. The spray unit 10 is also detachably attached to the top plate 39. In the illustrated electrostatic atomizer 66, the atomization electrode 2 is spaced downward away from the spray unit 10 so that a mist sprayed from the spray 1 is atomized into fine droplets by electrical discharge between the atomization electrode 2 and the discharge protruding portion 11 of the spray 1.

The spray case 67 of FIG. 2 or 3 is connected to the blower 28 of the gas supply device 9. Thus, the carrying gas is supplied to the interior space of the spray case 67 after being forcedly blown by the blower 28. In the illustrated spray case 67, the inlet 31 is opened on the inner surface of the upper part of the cylindrical portion 30. The carrying gas supplied from the blower 28 is flown in the tangential direction of the cylindrical portion 30 through the inlet 31. In the illustrated spray case 67, the inlet 31 is arranged opened at the substantially same height as the atomization electrode 2. Since the carrying gas flown through the inlet 31 is flown at the same height as the atomization electrode 2, it is possible to suppress that a mist adheres to the atomization electrodes 2. The illustrated spray case 67 is connected to one inlet duct 38 which extends in the tangential direction from a part of the peripheral surface of the cylindrical portion 30 so that the inlet 31 is opened in the spray case 67. Thus, the carrying gas is flown in the tangential direction of the cylindrical portion 30 through the inlet 31. It should be noted that, although not illustrated, a plurality of inlets may be formed in the interior surface of the cylindrical portion so that the carrying gas is flown in the tangential direction through the plurality of inlets. According to this construction, in addition to effective prevention of adhesion of a mist to the atomization electrode, it is possible to rotate the carrying gas supplied from the blower in the horizontal plane whereby efficiently classifying droplets of the mist supplied from the spray by centrifugal means. The carrying gas supplied in the tangential direction rotates the atomization mist produced by the spray 1 in the spray case 67 which is the cyclone classifier 70 of the mist classifier 4. Thus, the droplets of the mist can be classified according to the sizes of the droplets by centrifugal means.

The spray case 67 has the air outlet 33 which is opened at the center of the top plate 39 for discharging the carrying gas. In the illustrated spray case 67, the discharge duct 35 is arranged at the center of the top plate 39, and penetrates the top plate 39 so that the air outlet 33 is opened in the interior space of the spray case 67. Thus, carrying gas containing fine droplets of a mist is discharged upward from the spray case 67 and carried for the subsequent process.

In the case where the electrostatic atomizer 66 includes the spray case 67 which also served as the cyclone classifier 70 of the mist classifier 4, after a mist is produced by the spray 1 and is atomized by electrical discharge between the discharge protruding portion 11 of the spray 1 and the atomization electrode 2, droplets of the atomization mist can be classified according to the particles sizes of the droplets and be discharged from the electrostatic atomizer 66. Larger droplets of a mist (a mist of seawater) remain which are not atomized into fine droplets by electrical discharge by the atomization electrode 2. The larger droplets of a mist gather on and move downward along the interior surface of the cylindrical portion 30. Thus, the larger droplets of a mist can be discharged through the drain outlet 32. Accordingly, it is possible to extremely reduce the mean particle size of droplets of a mist discharged through the air outlet 33. In addition, according to this desalination apparatus, since the spray case 67 also serves as the cyclone classifier 70, the construction of the desalination apparatus can be simplified.

The desalination apparatus shown in FIG. 3 includes a plurality of mist classifiers 4 of cyclone classifiers 70 which are serially connected to each other so that the concentration of chloride is reduced in collected fresh water. That is, in the illustrated desalination apparatus, cyclone classifiers 70B are connected between the cooling collector 50 and a cyclone classifier 70A which also serves as the spray case 67. Specifically, in the illustrated desalination apparatus including a number of cyclone classifiers 70 connected to each other, the cyclone classifier 70A as first-stage classifier is connected on the upstream side to two cyclone classifiers 70B as second-stage classifiers connected on the downstream side. The two cyclone classifiers 70B are connected in parallel to each other. The inside diameter of the second-stage cyclone classifiers 70B is smaller than the inside diameter of the first-stage cyclone classifier 70A. According to this desalination apparatus, the rotational speed of the carrying gas can be high which rotates in the second cyclone classifier 70B. As a result, it is possible to efficiently collect fine droplets of a mist. Also, according to this desalination apparatus, fine droplets of a mist can be collected after droplets with high chloride concentration in the mist is removed by the multi-stage cyclone classifiers 70A and 70B connected serially to each other. Accordingly, it is possible to effectively reduce the chloride concentration of a mist which is included in the carrying gas after passing through the cyclone classifier 70. In addition, it is possible to efficiently collect fresh water with low chloride concentration in the cooling collector 50 in the subsequent process. As discussed above, in the desalination apparatus shown in FIG. 3, the cyclone classifiers 70 of two stages are serially connected to each other, and two cyclone classifiers 70B are provided as the second-stage cyclone classifiers. However, it should be noted that, in the case where the desalination apparatus includes cyclone classifiers of multi stages connected to each other, cyclone classifiers of three or more stages can be serially connected to each other. Also, three or more cyclone classifiers on the downstream side can be connected to each other in parallel.

As shown in FIG. 1 or 3, the mist collector 5 of the cooling collector 50 is connected to the discharging sides of the cyclone classifiers 70 of the mist classifiers 4. The mist of fresh water is separated and collected from the carrying gas discharged from the cyclone classifiers 70. The illustrated cooling collector 50 includes a heat exchanger 41 for cooling so that the droplets of a mist gather. The heat exchanger 41 for cooling has a fin 43 which is secured to the heat exchanging pipe 42. A refrigerant or cooling water for cooling is circulated through the heat exchanging pipe 42 so that the cooling heat exchanger 41 is cooled.

The illustrated mist collector 5 of the cooling collector 50 is connected to a cooling device 45 or 55 which supplies a refrigerant to the heat exchanger 41 for cooling. The cooling device 45 or 55 includes a compressor 46, a condenser 47, and an expansion valve 48. The compressor 46 pressurizes a gas of the refrigerant. The condenser 47 cools and liquefies the gas pressurized by the compressor 46. The expansion valve 48 supplies the refrigerant liquefied by the condenser 47 to the heat exchanging pipe 42 of the heat exchanger 41 for cooling. The cooling device 45 or 55 supplies the liquefied refrigerant to the heat exchanging pipe 42 through the expansion valve 48, and vaporizes the refrigerant inside the heat exchanging pipe 42 when the refrigerant is supplied to the cooling device 45 or 55. Thus, the heat exchanger 41 for cooling is cooled by heat of vaporization. The vaporized refrigerant is pressurized by the compressor 46 and is supplied to the condenser 47. Subsequently, the supplied refrigerant is liquefied by the condenser 47, and is supplied to the heat exchanging pipe 42 through the expansion valve 48. The expansion valve 48 thermally insulatedly expands the refrigerant, and vaporizes the refrigerant in the heat exchange pipe 42. Thus, the heat exchanger 41 for cooling is cooled by heat of vaporization of the refrigerant. However, the heat exchanger for cooling is not cooled necessarily by heat of vaporization of a refrigerant. For example, the heat exchanging pipe can be cooled by a circulated, cooled liquid.

When the refrigerant is circulated in the heat exchanger 41 for cooling, the heat exchanger 41 for cooling cools the refrigerant by using heat of vaporization of the refrigerant itself. Also, the carrying gas to be flown back to the electrostatic atomizer can be warmed by using heat of condensation of the refrigerant. In the cooling device 55 shown in FIGS. 2 and 3, a heat exchanger 49 for heating is connected between the compressor 46 and the condenser 47. The heat exchanger 49 for heating is thermally connected to a transmission duct 29 for circulating the carrying gas. In this cooling device 55, the refrigerant is pressurized by the compressor 46 so that the pressurized refrigerant is supplied to the heat exchanger 49 for warming. The heat exchanger 49 for warming dissipates heat of the refrigerant and liquefies the refrigerant. Thus, the heat exchanger 49 for warming is warmed by heat of condensation of the refrigerant. The heat exchanger 49 for heating is warmed by the refrigerant, and warms the carrying gas which is discharged from the cooling collector 50 and supplied to the electrostatic atomizer 66. Since the carrying gas is thus warmed, it is possible to improve the efficiency of atomization of seawater into a mist atomized by the electrostatic atomizer 66.

In the cooling device of the cooling collector, the heat exchanger for cooling can use seawater. The cooling device supplies the seawater to the heat exchanging pipe of the heat exchanger for cooling. In particular, in the case where deep sea water at depth of 200 m or more is used, the heat exchanger for cooling can be cooled to low temperature so that fine droplets of a mist can be efficiently collected.

In the aforementioned mist collector 5 of the cooling collector 50, a mist contained in the carrying gas is cooled and condensed by the heat exchanger 41 for cooling. In addition, a mist of fresh water contained in the carrying gas will be partially vaporized. Accordingly, the carrying gas also contains water vapor. In the case where carrying gas is cooled by the heat exchanger 41 for cooling, the vaporized water vapor can be also be condensed and gather. As a result, it is possible to efficiently collect the water vapor. When a mist is flown together with the carrying gas into the cooling collector 50, droplets of the mist will collide with the heat exchanger 41 for cooling. Also, droplets of the mist will collide with each other, and gather into larger droplets. Also, droplets of the mist will collide with the fin 43 or the like, and gather into larger droplets. Thus, the droplets of the mist can be collected as fresh water. After a mist of the fresh water is separated from the carrying gas by the heat exchanger 41 for cooling, the carrying gas is flown back to the electrostatic atomizer 6 or 66.

In the illustrated cooling collector 50, the drain outlet 52 is formed at the lower end of the mist collector 5. Larger droplets of a mist of fresh water gather and move downward along the inner surface of the cooling collector 50. Also, droplets of fresh water drop from the heat exchanger 41 for cooling after adhering onto the heat exchanger 41 for cooling. The collecting tank 56 collects the gathering larger droplets of a mist and the droplets dropping from the heat exchanger 41 for cooling through the drain outlet 52. The drain outlet 52 has a discharge liquor trap 57 which is bent in U shapes and prevents the carrying gas from being discharged. The discharge liquor trap 57 is formed from two U-bent parts 57A, and stores a certain amount of discharge liquor to be discharged whereby preventing the carrying gas from being discharged. According to this construction, the carrying gas can be completely prevented from being discharged, while the dropping liquid can be collected. It should be noted that the drain outlet can use a filter which prevents the carrying gas from passing through the filter but allows the liquid to pass through the filter so that the carrying gas is prevented from being discharged while the liquid can pass through the drain outlet.

The aforementioned desalination apparatus uses carrying gas which carries a mist and is circulated. The thus-constructed desalination apparatus uses carrying gas such as hydrogen, helium, and nitrogen for carrying a mist. The desalination apparatus preferably uses hydrogen or helium as the carrying gas. It should be noted that the carrying gas be a gas of mixed hydrogen and helium, a mixture gas of hydrogen and air, a mixture gas of the helium and air, or a mixture gas of hydrogen, helium and air. Alternatively, the carrying gas may be an inert gas.

According to the desalination apparatus which uses circulated carrying gas, the carrying gas is not exhausted to the outside. Accordingly, even fresh water is not collected once by the mist collector 5, the fresh water is repeatedly circulated and passes through the mist collector 5. As a result, it is possible to efficiently collect fresh water. On the other hand, in the case where hydrogen, helium or the like is used, it is possible to reduce the running cost. However, the carrying gas for the desalination apparatus is not limited to these gases. Air can also be used. Air can be circulated and used. Alternatively, air may be used without circulated. In the case where the desalination apparatus does not circulate air, fresh air can be sucked by a gas supplier and is supplied to the spray case by the blower.

Fresh water obtained by the seawater desalination apparatus of the present invention can be further filtered by a separation membrane of reverse osmosis membrane which passes only fresh water. Since chloride concentration can be very low of fresh water obtained by the apparatus according to the present invention, the separation membrane such as reverse osmotic membrane is less likely to be clogged. Therefore, it is possible to efficiently filter the obtained fresh water. Since the seawater desalination apparatus according to the present invention sprays seawater and electrostatically atomizes the sprayed seawater into a mist, the seawater can be sterilized whereby producing sterilized fresh water in this process. In addition, in the case where thus-produced fresh water is further filtered, dissolved matters and the like in the water can be removed. Therefore, it is possible to produce high quality fresh water.

### INDUSTRIAL APPLICABILITY

According to the seawater desalination apparatus of the present invention, a large amount of seawater can be efficiently desalinated with extremely reducing energy consumption.

### REFERENCE SIGNS LIST

| | | | |
|---|---|---|---|
| 1 | Spray | | |
| 2 | Atomization electrode | 2A | Metal ring |
| | | 2B | Metal net |
| 3 | High voltage power supply | | |
| 4 | Mist classifier | | |
| 5 | Mist collector | | |
| 6 | Electrostatic atomizer | | |
| 7 | Spray case | | |
| 9 | Supply device | | |
| 10 | Spray unit | | |
| 11 | Electrical discharge protruding portion | | |
| 12 | Fine spray aperture | | |
| 13 | Capillary tube | | |
| 14 | Nozzle block | 14A | Main portion |
| | | 14B | Plate-shaped portion |
| | | 14a | Flange |
| | | 14b | Stepped portion |
| | | 14c | Cylindrical portion |
| | | 14d | external threads |
| | | 14e | Coupling hole |
| | | 14x | Through hole |
| 15 | Packing member | | |
| 16 | Sandwiching plate | 16x | Through hole |
| 17 | Supply socket | | |
| 18 | Coupling bolt | | |
| 20 | Attachment portion | | |
| 21 | Spray chamber | | |
| 22 | Air chamber | | |
| 23 | Partitioning wall | | |
| 24 | Blowing aperture | | |
| 25 | Pump | | |
| 26 | Seawater tank | | |
| 28 | Blower | | |
| 29 | Transmission duct | | |
| 30 | Cylindrical portion | 30A | Tapered part |
| 31 | Inlet | | |
| 32 | Drain outlet | | |
| 33 | Air outlet | | |
| 34 | Top plate | | |
| 35 | Discharge duct | | |
| 36 | Collecting tank | | |
| 37 | Discharge liquor trap | 37A | U-shaped portion |
| 38 | Inlet duct | | |
| 39 | Top plate | | |
| 40 | Attachment portion | | |
| 41 | Heat exchanger for cooling | | |
| 42 | Heat exchanging pipe | | |
| 43 | Fin | | |
| 45 | Cooling device | | |
| 46 | Compressor | | |
| 47 | Condenser | | |
| 48 | Expansion valve | | |
| 49 | Heat exchanger for heating | | |
| 50 | Cooling collector | | |
| 52 | Drain outlet | | |
| 55 | Cooling device | | |
| 56 | Collecting tank | | |
| 57 | Discharge liquor trap | 57A | U-shaped portion |
| 61 | Spray chamber | | |
| 66 | Electrostatic atomizer | | |
| 67 | Spray case | | |
| 70 | Cyclone classifier | 70A | Cyclone classifier |
| | | 70B | Cyclone classifier |

1. A seawater desalination apparatus comprising:
a spray (1) that includes a plurality of spraying apertures that spray seawater and produce a mist of the seawater;
a gas supply device (9) that supplies carrying gas for carrying the spray mist, which is produced by said spray (1);
an atomizing electrode (2) that electrostatically produces fine droplets as an atomization mist from the spray mist, which is produced by said spray (1);
a high voltage power supply (3) that is connected to the atomizing electrode (2) and said spray (1), and applies a high voltage between said atomizing electrode (2) and said spray (1) for the production of fine droplets from the spray mist, which is produced by said atomizer (1);
a mist classifier (4) that classifies the fine droplets as an atomization mist, which are produced by said atomizing electrode (2), according to the particle sizes of the fine droplets; and
a mist collector (5) that collects the fine droplets as an atomization mist, which are classified by said mist classifier (4), whereby producing fresh water.

2. The seawater desalination apparatus according to claim 1, wherein said mist classifier (4) is a cyclone classifier (70).

3. The seawater desalination apparatus according to claim 2, wherein a plurality of mist classifiers (4) are included as said cyclone classifier (70), wherein the cyclone classifiers (70) are serially connected to each other.

4. The seawater desalination apparatus according to claim 3, wherein said cyclone classifiers (70), which are serially connected to each other, include an upstream-side cyclone classifier (70A) that is connected on the upstream-side of the carrying gas and a downstream-side cyclone classifier (70B) that is connected on the downstream-side of the carrying gas, wherein the inside diameter of the downstream-side cyclone classifier (70B) is smaller than the inside diameter of the upstream-side cyclone classifier (70A).

5. The seawater desalination apparatus according to claim 1, wherein said mist collector (5) is a cooling collector (50) which cools the carrying gas containing the mist whereby producing fresh water.

6. The seawater desalination apparatus according to claim 5, wherein said cooling collector (50) includes a heat exchanger (41) for cooling the carrying gas containing the mist, wherein a refrigerant or cooling liquid for cooling is circulated through a heat exchanging pipe (42) of the heat exchanger (41) whereby cooling the cooling heat exchanger (41).

7. The seawater desalination apparatus according to claim 6, wherein
the cooling collector (50) is connected to a cooling device (55) that supplies the refrigerant to the heat exchanger (41) for cooling, wherein the cooling device (55) includes
a compressor (46) that pressurizes the refrigerant,
a condenser (47) that cools and liquefies the gas pressurized by the compressor (46),
an expansion valve (48) that supplies the refrigerant liquefied by the condenser (47) to the heat exchanging pipe (42) of the heat exchanger (41) for cooling, and
a heat exchanger (49) for heating is connected between the compressor (46) and the condenser (47), wherein
the heat exchanger (49) for heating is thermally connected to a transmission duct (29) for circulating the carrying gas.

8. The seawater desalination apparatus according to claim 5, wherein a drain outlet (52) is formed at the lower end of the cooling collector (50), wherein the drain outlet (52) is connected to a collecting tank (56) through a discharge liquor trap (57).

9. The seawater desalination apparatus according to claim 1, wherein said spray (1) includes a plurality of spray units (10), wherein each of the spray units (10) includes a number of fine spraying apertures (12) as said spraying apertures for electrical discharge in cooperation with said atomizing electrode (2) whereby producing the fine droplets as the atomization mist, wherein the atomizing electrode (2) produces the fine droplets as the atomization mist from the spray mist produced from each of the fine atomizing apertures (12).

10. The seawater desalination apparatus according to claim 9, wherein the spray unit (10) includes a plurality of capillary tubes (13), and a nozzle block (14) that holds the plurality of capillary tubes (13), wherein the capillary tubes (13) are small metal tubes, wherein the ends of the capillary tubes (13) serve as electrical discharge protruding portions (11), and the inner center apertures of the capillary tubes (13) serve as the fine spray apertures (12).

11. The seawater desalination apparatus according to claim 10, wherein the protruding amount of the capillary tube (13) arranged in the center part of the nozzle block (14) is higher than the capillary tubes (13) on the outer peripheral part so that the imaginary surface defined by the ends of the plurality of capillary tubes (13) has a convex shape the highest point of which is located at the center of the nozzle block.

12. The seawater desalination apparatus according to claim 10, wherein the atomization electrode (2) is an annular metal ring (2A), and is arranged at a position corresponding to the peripheries of the capillary tubes (13), which is attached to the nozzle block (14).

13. The seawater desalination apparatus according to claim 10, wherein the atomization electrode (2) is a metal net (2B), and is spaced away from the discharge protruding portions (11) in the mist spraying direction.

14. The seawater desalination apparatus according to claim 1 further comprising a spray case (7) that includes a spray chamber (21), said spray unit (10) spraying the seawater into the spray chamber and producing the mist of the seawater, wherein said spray case (7) has a blowing aperture (24) through which the carrying gas is blown into the space between the spray units (10) adjacent to each other, wherein the blowing aperture (24) is communicated with said gas supply device (9).

15. The seawater desalination apparatus according to claim 14, wherein said spray case (7) is connected to said mist classifier (4).

16. The seawater desalination apparatus according to claim 14, wherein the atomizing electrode (2) is arranged on the path of the carrying gas, which is blown through said blowing aperture (24), in said spray chamber (21).

17. The seawater desalination apparatus according to claim 2 further comprising a spray case (67) that includes a spray chamber (61), said spray unit (10) spraying the seawater into the spray chamber and producing the mist of the seawater, wherein said spray case (67) is a cyclone classifier (70) as the mist classifier (4), wherein said cyclone classifier (70) includes
a drain outlet (32) that limits the discharge of the carrying gas and drains the mist which drops in the spray chamber (61), and
an air outlet (33) that is opened in the central part of the cyclone classifier and discharges the mist carried together with the carrying gas, wherein
the carrying gas containing the mist is carried into the mist collector (5) after discharged through the air outlet (33).

18. The seawater desalination apparatus according to claim 14, wherein said spray case (7; 67) includes an attachment portion (20; 40) that detachably holds the plurality of spray units (10) so that the detachably-held spray units (10) can be replaced.

19. The seawater desalination apparatus according to claim 9, wherein the inside diameter of said fine spray aperture (12) is not more than 0.5 mm.

20. The seawater desalination apparatus according to claim 9, wherein the number of fine spraying apertures (12) of said spray unit (10) is not less than ten.
